(19) United States
(12) Patent Application Publication
(10) Pub. No.: US 2015/0129488 A1
(43) Pub. Date: May 14, 2015

(54) FILTERING SOLID

(71) Applicant: CHING-CHAO LIN, TAINAN CITY (TW)

(72) Inventor: CHING-CHAO LIN, TAINAN CITY (TW)

(21) Appl. No.: 14/076,375

(22) Filed: Nov. 11, 2013

(51) Int. Cl. C02F 1/00; A01K 63/04

(52) U.S. Cl. CPC C02F 1/001; A01K 63/045; C02F 2201/002; C02F 2103/20
USPC 210/497.01; 210/483

(57) ABSTRACT

A filtering solid includes a body, the body includes at least two surfaces defined thereon, and at least one accommodating room is formed thereon. The accommodating room penetrates through the two surfaces, and at least one wall surface is formed at an interior of the accommodating room. The body is a cube or a cylinder; the accommodating room is a circular through hole or a square through hole. The filtering solid attains the purposes of reaching a maximum storage of water and increasing an adhering area of nitrifying bacteria in a limited volume.

### BACKGROUND OF THE INVENTION

1. Field of the Invention

The present invention relates to a filtering solid, particularly to a structure of the filtering solid which can roll in wastewater and increase an adhering area of nitrifying bacteria for increasing the decomposition efficiency and a growth speed of nitrifying bacteria.

2. Description of the Related Art

Ordinary filtering apparatus used in aquariums or the aquaculture can be divided into a physical filter and a biological filter. The physical filter is mainly used to remove the left bait in water and the excrement of fishes. The biological filter is mainly used to cultivate nitrifying bacteria and purify water quality by placing a biological spheroid or a biological lump. The use of the biological filter has the preferable effect. Therefore, there is disclosed a prior art published on Nov. 21, 2005 by Taiwan utility model no. M280855 and titled by “Biological filtering material for purifying the water quality” which comprises a hollow shell and a plurality of pipes with inner holes. A circumferential wall of the hollow shell has a plurality of openings penetrating the interior thereof. The pipe provides a pipe portion extended into the hollow shell. As a result, a room suitable for the growing and breeding of nitrifying bacteria or other bacteria is formed. Further, a connecting component providing inner openings is assembled into some openings of the hollow shell for forming a biological filtering material group with any sizes by connecting multiple hollow shells in series or piling them, thereby increasing a larger surface area for the adhesion of bacteria and impurities and increasing the biological filtering effect. However, the interior of the prior biological filtering material is circular and hollow, so the water cannot be effectively stored, and each part of the interior and the exterior of the biological filtering material cannot completely contact with dissolved oxygen or ammonia in the water when the material is installed in the water. As a result, the area for cultivating the nitrifying bacteria is considerably limited, and a waste of the filtering material is caused. Because the water inside and outside of the filtering material is not apt to interchange, the effect of dissolved oxygen is not good.

There is disclosed a further prior art published on Dec. 11, 1996 by Taiwan patent no. 239243 and titled by “Porous glass fiber ceramic filtering material used in the aquarium” which comprises a plurality of stuffed porous glass fiber ceramic monomers. The cross section of the monomer is an oval object in a solid circular shape, and multiple stripped grooves are radially formed on an outer circumference of the monomer. Alternatively, the monomer can be a short tubular object in a hollow circular shape, and multiple rows of sharp wings and the corresponding grooves are protruded from the outer circumference of the monomer. The invention provides expanded interstices with lots of pores on the surface adequate for the growing, adhesion, and breeding of aerobic active mycelium and anaerobic active mycelium. Therefore, the prior disclosure can convert the toxicant ammonia (NH3) in the water into a harmless nitric acid (NO3) effectively and then convert the nitric acid (NO3) into nitrogen (N2) for evaporation. By cultivating the two active mycelia, the water quality keeps good and is not apt to become yellow to prolong time of changing water.

Nevertheless, the multiple radial sharp wings and corresponding grooves make the prior disclosure more complex and cause the plurality of biological filtering materials unable to be connected in series. The prior disclosure with a bigger volume and more manufacturing materials occupies a considerably big filtering space for the installation, which cannot obtain the preferable effect of dissolved oxygen and cannot obtain a good use effect.

There is disclosed a further prior art published on Nov. 11, 2001 by Taiwan patent no. 463854 and titled by “Apparatus of the cultivation of bacteria in toilet liquid” which discloses an apparatus for cultivating the nitrifying bacteria which can eliminate the ammonia. The disclosure comprises a generator and a plurality of biochemical grooves offered for allowing nitrifying bacteria to be temporarily stored and cultivated formed inside the generator. The generator is made by a material which produces far infrared rays, whereby the generator subjects molecules of water to a stimulating activation, provides a good environment for the breeding and cultivation of nitrifying bacteria, and allows the water flushed by the toilet to decompose the ammonia. Therefore, an auto-deodorization effect is obtained.

Nonetheless, the prior biological material is still in a shape of straight pipe, and the water outside the biological material cannot enter it from both sides. Consequently, the inside and outside water cannot interchange easily and cannot completely contact with the dissolved oxygen and the ammonia in the water. The effect of dissolved oxygen is bad, and the area for cultivating the nitrifying bacteria is limited. Therefore, the use effect is not good.

### SUMMARY OF THE INVENTION

Because the present biological filtering materials which are used in the aquarium and aquaculture have the aforementioned drawbacks, the present invention provides a filtering solid comprising a body, the body provides at least two surfaces defined thereon, and a least one accommodating room is formed thereon. The accommodating room penetrates through the two surfaces, and at least one wall surface is formed at the interior of the accommodating room.

The body is a cube or a cylinder.

The accommodating room is a circular through hole or a square through hole.

The present invention provides advantages as follows:

1. While the body is flushed by a stream or the bubbles, an imbalance of the body is generated. Consequently, the body can continually roll in the wastewater and completely contact with the wastewater, thereby increasing the efficiency of using the nitrifying bacteria to decompose the ammonia in the water and facilitating a rapid growth of the nitrifying bacteria.

2. The present invention introduces the oxygen into the wastewater and benefits the growing of nitrifying bacteria by giving the nitrifying bacteria sufficient dissolved oxygen, whereby the wastewater is fast purified and the decomposition efficiency of filtering is increased.

3. The present invention mainly uses at least one wall surface formed inside each accommodating room of the body to have the maximum storage of water and increase the adhering area of nitrifying bacteria in the limited volume.

### BRIEF DESCRIPTION OF THE DRAWINGS

FIG. 1 is a perspective section showing a first embodiment of the present invention;

FIG. 2 is a schematic view showing the first embodiment of the present invention in use;

FIG. 3 is a perspective section showing a second embodiment of the present invention;

FIG. 4 is a schematic view showing the second embodiment of the present invention in use;

FIG. 5 is a perspective section showing a third embodiment of the present invention;

FIG. 6 is a schematic view showing the third embodiment of the present invention in use;

FIG. 7 is a perspective section showing a fourth embodiment of the present invention; and

FIG. 8 is a schematic view showing the fourth embodiment of the present invention in use.

### DETAILED DESCRIPTION OF THE PREFERRED EMBODIMENTS

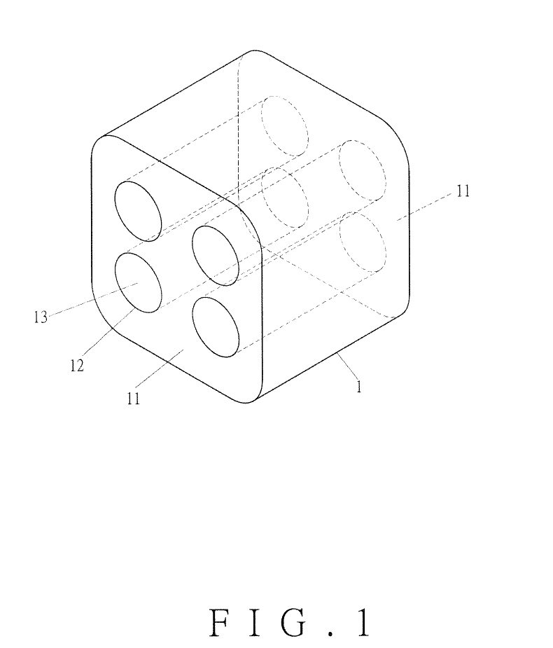

Firstly, referring to FIG. 1, a first embodiment of the present invention comprises a cubic body (1), the body (1) provides at least two surfaces (11) defined thereon, and at least one accommodating room (12) which is a circular through hole is formed thereon. The accommodating room (12) penetrates through the two surfaces (11), and the interior therein is offered to store water. At least one wall surface (13) is formed at the interior of the accommodating room (12) for the adhesion and accommodation of nitrifying bacteria.

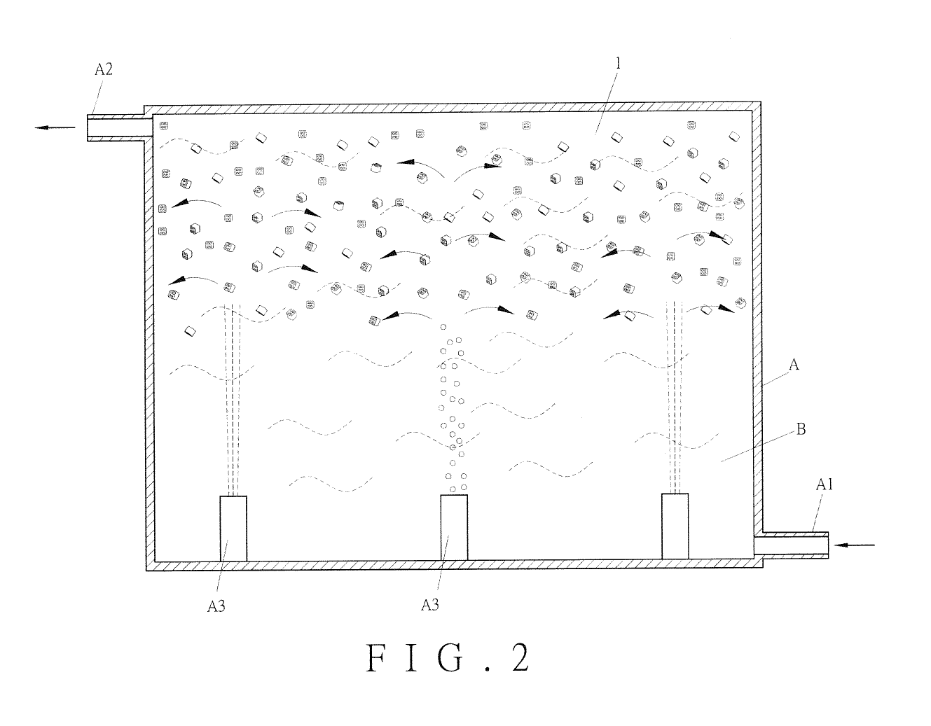

While using, as shown in FIG. 1 and FIG. 2, an appropriate amount of the bodies (1) are placed into a filtering groove (A). The wastewater (B) needed to be filtered is led from a water input (A1), and the filtered wastewater (B) is outputted from a water output (A2). The oxygen can be previously dissolved in the wastewater (B) while the wastewater (B) is led; consequently, the oxygen content of the wastewater (B) is increased. At least one flow power output (A3) is applied to input a stream or bubbles, and the body (1) can be flushed in the wastewater (B) by the stream or bubbles. Since the body (1) is directly flushed by the stream or bubbles, the body (1) creates an imbalance by a pushing force, rolls incessantly in the wastewater (B), and uses the water stored in the accommodating room (12) and the wastewater (B) which incessantly passes through the accommodating room (12) to allow the nitrifying bacteria cultivated on the wall surface (13) of the accommodating room (12) to be in contact with the wastewater (B) sufficiently. The nitrifying bacteria on each part of the wall surface (13) can decompose the ammonia in the wastewater (B) completely while the rolling body (1) contacts with the wastewater (B) sufficiently. Therefore, the water quality can be purified, and the nitrifying bacteria can also absorb the dissolved oxygen in the wastewater (B) to increase the decomposition efficiency and the growth speed of the nitrifying bacteria. Accordingly, the present invention uses the accommodating room (12) penetrating through the body (1) to store the water and increase the adhering area of the nitrifying bacteria, whereby the efficiency of purifying the water quality is increased.

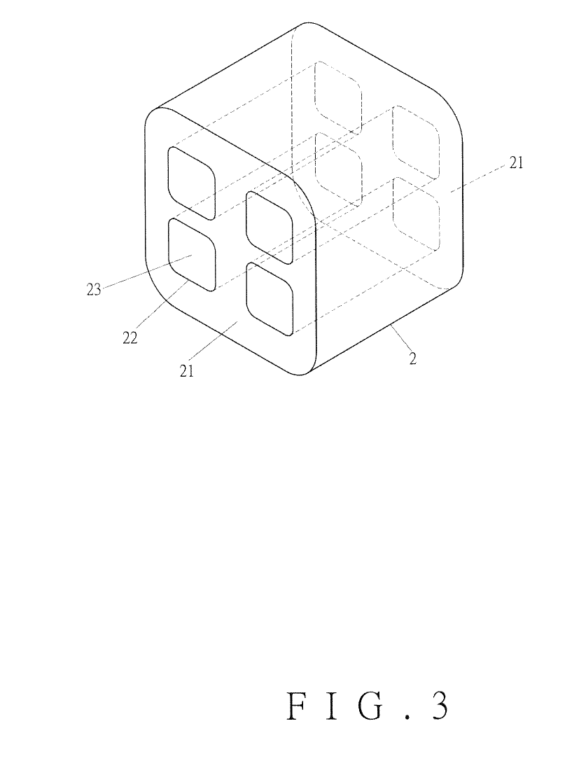

A second embodiment of the filtering solid as shown in FIG. 3 comprises a cubic body (2), the body provides at least two surfaces (21) defined thereon, and at least one accommodating room (22) which is a square through hole is formed thereon. The accommodating room (22) penetrates through the two surfaces (21) and the interior of it is offered to store the water; at least one wall surface (23) is formed at the interior of the accommodating room (22). In this embodiment, the accommodating room (22) with square through holes provides four wall surfaces (23) for the adhesion and accommodation of nitrifying bacteria.

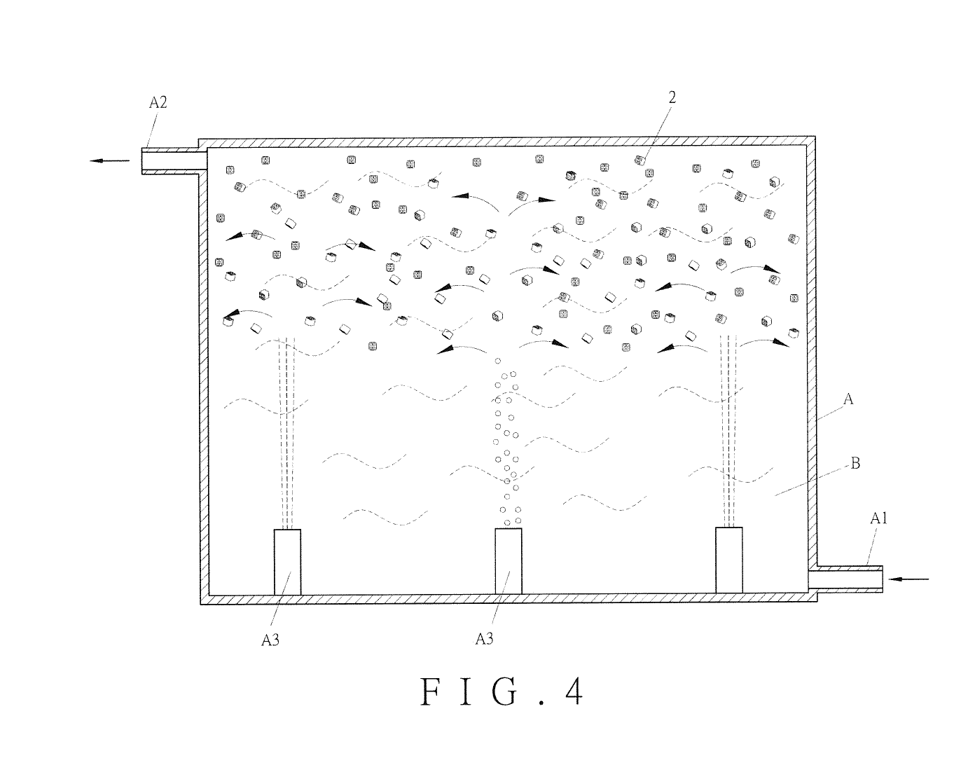

While using, as shown in FIG. 3 and FIG. 4, an appropriate amount of the bodies (2) are disposed in the filtering groove (A). The wastewater (B) needed to be filtered is led from the water input (A1), and the filtered wastewater (B) is outputted from the water output (A2). Use at least one flow power output (A3) to input a stream or the bubbles, and the body (2) can be flushed in the wastewater (B) by the stream or bubbles. Use the interior of the accommodating room (22) to store water and allow the nitrifying bacteria cultivated on the wall surface (23) of the accommodating room (22) to contact with the wastewater (B) sufficiently, decompose the ammonia in the wastewater completely, and increase the decomposition efficiency of filtering and the growth speed of nitrifying bacteria, whereby the efficiency of purifying the water quality is increased.

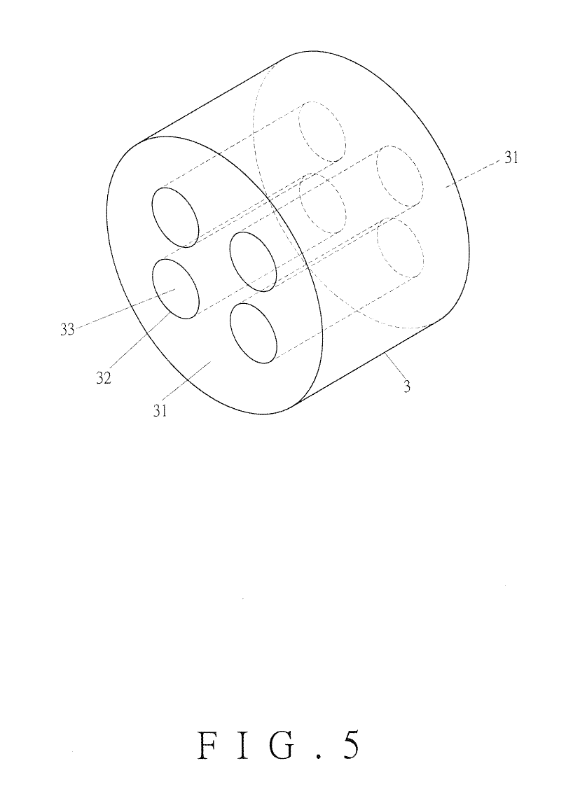

The third embodiment of the present invention as shown in FIG. 5 comprises a cylinder body (3), the body (3) provides at least two surfaces (31) defined thereon, and at least one accommodating room (32) which is a circular through hole is formed thereon. The accommodating room (32) penetrates through the two surfaces (31) and the interior of it is offered to store water; at least one wall surface (33) is formed at the interior of the accommodating room (32) for the adhesion and accommodation of nitrifying bacteria.

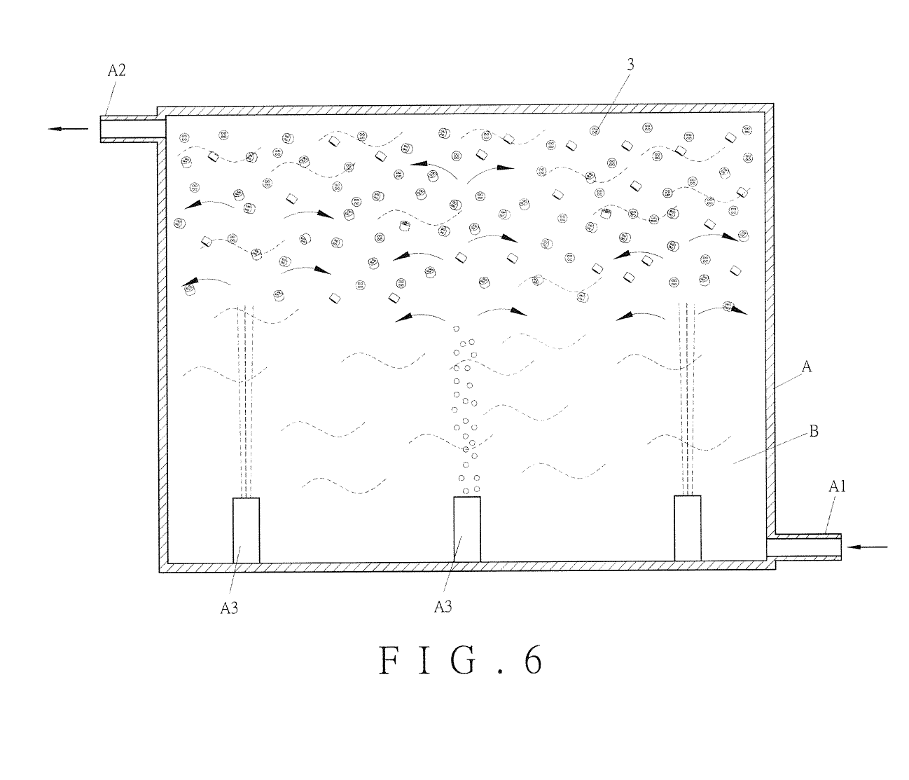

While using, as shown in FIG. 5 and FIG. 6, an appropriate amount of the bodies (3) are disposed in the filtering groove (A). The wastewater (B) needed to be filtered is led from the water input (A1), and the filtered wastewater (B) is outputted from a water output (A2). A stream or the bubbles are inputted from at least one flow power output (A3), and the body (3) can be flushed in the wastewater (B) by the stream or bubbles. Use the interior of the accommodating room (32) to store the water and allow the nitrifying bacteria cultivated on the wall surface (33) of the accommodating room (32) to contact with the wastewater (B) sufficiently, decompose the ammonia of the wastewater completely, and increase the decomposition efficiency of filtering and the growth speed of nitrifying bacteria, whereby the efficiency of purifying the water quality is increased.

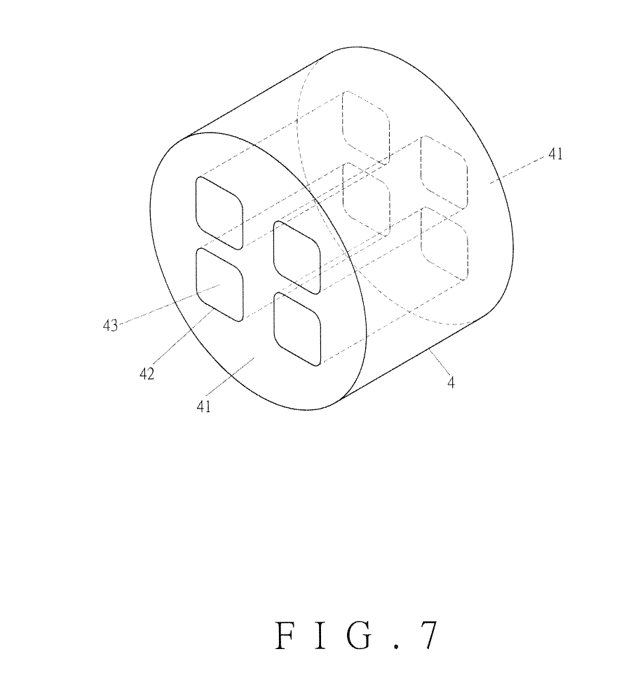

The fourth embodiment of the present invention as shown in FIG. 7 comprises a cylinder body (4), the body provides at least two surfaces (41) defined thereon, and at least one accommodating room (42) which is a square through hole is formed thereon. The accommodating room (42) penetrates through the two surfaces (41) and the interior of it is offered to store the water; at least one wall surface (43) is formed at the interior of the accommodating room (42). In this embodiment, the accommodating room (42) with square through holes provides four wall surfaces (43) for the adhesion and accommodation of the nitrifying bacteria.

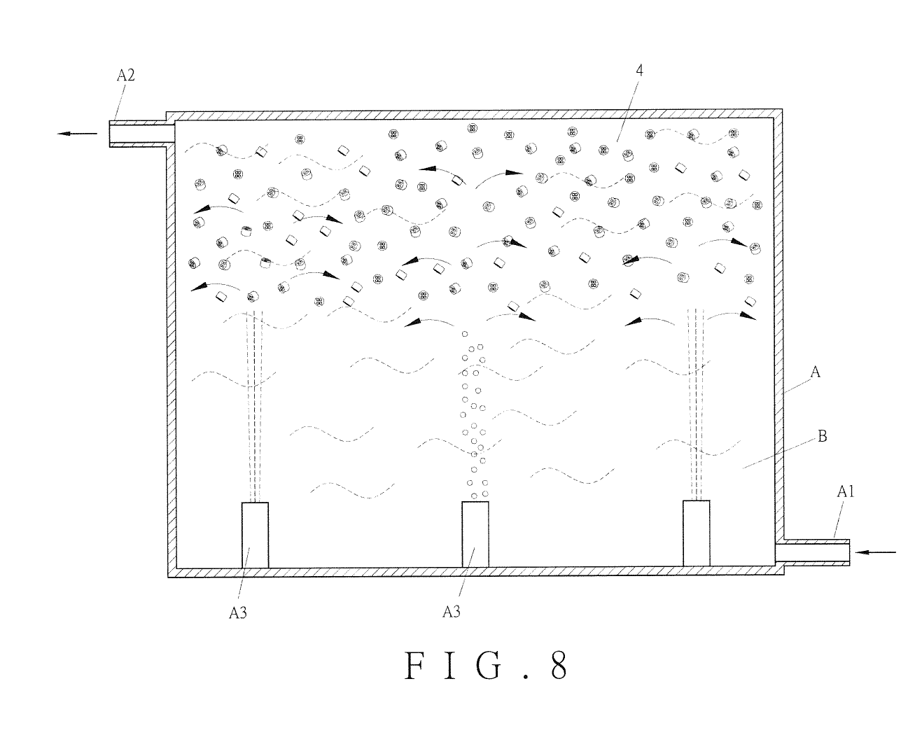

While using, as shown in FIG. 7 and FIG. 8, an appropriate amount of the bodies (4) are disposed in the filtering groove (A). The wastewater (B) needed to be filtered is led from the water input (A1), and the filtered wastewater (B) is outputted from a water output (A2). A stream or the bubbles are inputted from at least one flow power output (A3), and the body (4) can be flushed in the wastewater (B) by the stream or bubbles. Use the accommodating room (42) to store the water and allow the nitrifying bacteria cultivated on the wall surface (43) of the accommodating room (42) to contact with the wastewater sufficiently, decompose the ammonia in the water completely, and increase the decomposition efficiency of filtering and the growth speed, whereby the efficiency of purifying the water quality is increased.

While we have shown and described the embodiment in accordance with the present invention, it should be clear to those skilled in the art that further embodiments may be made without departing from the scope of the present invention.

What is claimed is:

1. A filtering solid comprising a body, said body including at least two surfaces defined thereon, and said body including at least one accommodating room formed thereon; said accommodating room penetrating through said two surfaces, and at least one wall surface being formed at an interior of said accommodating room.

2. A filtering solid as claimed in claim 1, wherein said accommodating room is a circular through hole or a square through hole.

3. A filtering solid as claimed in claim 1, wherein said body is a cube or a cylinder.

4. A filtering solid as claimed in claim 3, wherein said accommodating room is a circular through hole or a square through hole.
